(19) United States
(12) Patent Application Publication
(10) Pub. No.: US 2008/0186396 A1
(43) Pub. Date: Aug. 7, 2008

(54) DISPLAY APPARATUS AND DISPLAY PROGRAM

(75) Inventors: Kenji Nakajima, Kawasaki (JP); Katsuhiko Akiyama, Kawasaki (JP); Naomi Iwayama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/024,657

(22) Filed: Feb. 1, 2008

(30) Foreign Application Priority Data
Feb. 6, 2007 (JP) 2007-026860

(51) Int. Cl. H04N 5/222

(52) U.S. Cl. 348/333.01; 348/E05.022

(57) ABSTRACT

According to an aspect of the invention, a display apparatus includes: an image acquisition part which acquires image data of a page on which characters are written; an image reduction part which reduces the image data of the page at a predetermined reduction rate; a complexity degree calculation part which analyzes an image structure of the image data of a character in the image data, and calculates a complexity degree of the image structure; a reduction control part which determines the reduction rate for the image reduction so that the complexity degree is kept to a predetermined extent even after the reduction; an image display part which displays the image data reduced by the image reduction part so that the image better fills the display screen.

### CROSS-REFERENCE TO RELATED APPLICATIONS

This application is related to and claims priority under 35U.S.C §119(a) on Japanese Patent Application No. 2007-26860 filed on Feb. 6, 2007 in the Japan Patent Office, and incorporated by reference herein.

### BACKGROUND OF THE INVENTION

1. Field of the Invention

The present invention relates to a display apparatus for displaying an image in which characters are written, and a display program.

2. Description of the Related Art

Information which has been conventionally handwritten on paper is gradually inputted to a personal computer or the like with the use of a keyboard or the like and used as digital electronic data. For example, in hospitals, medical records in which patients' conditions are recorded have been replaced with digital electronic medical records. A purchase order document used for ordering a product and an order acceptance document for accepting an order of a product have also been digitalized. By handling information as digital electronic data, it becomes easy to store and copy the data. Furthermore, there is an advantage that the data can be shared via a network even if users stay at places apart from one another.

However, there are a lot of people who find it difficult to input information with the use of the keyboard of a personal computer among those who are familiar with handwriting information on paper. In consideration of this problem, an input device is known which, when a user performs drawing on the display screen of a personal computer or on a special tablet with a pen or a fingertip, detects the drawing position and acquires the contents of the drawing. According to such an input device, those who are not familiar with a keyboard can easily input information. Furthermore, additional processings, such as writing characters on an image and writing characters at a desired position, can be easily performed. Recently, a pen-input type input device has been widely applied to systems such as an electronic medical record system in which electronic medical records are inputted and managed together with patients' medical images, a delivery management system in which centralized management of the delivery state is performed by having a customer input a signature in exchange for goods, and a reception system in which visitor information and points in telephone responses are inputted to manage schedules and the like.

When multiple pieces of information are to be collectively confirmed, the pieces of information are displayed on a screen as a list. In the input device described above, it is common that characters and images written or drawn on the screen are collectively converted to an image, and page data indicating a page is generated with the whole screen as one page. Therefore, in order to execute the list display, multiple pages indicated by the respective multiple page data are arranged and displayed after being reduced. However, characters are written in each page with various sizes and thicknesses. Therefore, if the pages are reduced with the same reduction rate, a problem is caused in that small characters and thick characters are broken and the contents or description cannot be understood.

In consideration of this point, Japanese Patent Laid-Open No. 11-219260 discloses a technique for displaying each page by eliminating spaces where a character or an image is not written or drawn on the page. Japanese Patent Laid-Open No. 06-121151 discloses a technique for detecting the density of pixels in each page and judging whether or not characters are broken when reduced. By applying the techniques described in the above-mentioned patent documents to reduce each page, breakage of characters can be reduced.

### SUMMARY

According to an aspect of an embodiment, a display apparatus includes an image acquisition part which acquires image data of a page on which characters are written. An image reduction part reduces the image data of the page at a predetermined reduction rate, and an image display part displays the image data reduced by the image reduction part. A complexity degree calculation part analyzes an image structure of the image data by characters in the image data, and calculates a complexity degree on which a complexity of the image structure is reflected. A reduction control part determines the reduction rate for the image reduction by the image reduction part so that the complexity degree before the reduction is kept to a predetermined extent even after the reduction.

### BRIEF DESCRIPTION OF THE DRAWINGS

FIG. 1 is an external appearance perspective view of a personal computer to which an embodiment of the present invention is applied;

FIG. 2 is an external appearance perspective view showing an electronic apparatus with a second unit closed over a first unit;

FIG. 3 is an external appearance perspective view showing that the second unit is turned by almost 900 relative to the first unit;

FIG. 4 is an external appearance perspective view showing that the second unit is placed on the first unit with the display screen directed upward;

FIG. 5 is an internal configuration diagram of the personal computer;

FIG. 6 is a conceptual diagram showing a CD-ROM in which an input/display program is stored;

FIG. 7 is a functional block diagram of an input/display device constructed in the personal computer shown in FIG. 1 when the input/display program is installed in the personal computer;

FIG. 8 is an operation flow chart showing a series of processings for displaying a list of page images in the input/display device;

FIG. 9 is an operation flow chart showing a series of processings performed in a size analysis part, a character classification part and a reduction control part in FIG. 7, in the reduction rate adjustment processing shown at operation S3 in FIG. 8;

FIG. 10 is a graph showing an example of distribution of the sizes and the numbers of characters in a page image;

FIG. 11 is an operation flow chart showing a series of processings performed in a complexity degree calculation part, an image reduction part and the reduction control part in FIG. 7, in the reduction rate adjustment processing shown at operation S3 in FIG. 8;

FIGS. 12A and 12B are diagrams for illustrating a complexity degree calculation method;

FIG. 13 is an operation flow chart showing a series of processings performed in an extra space judgment part, a writing amount calculation part, the image reduction part and the reduction control part in FIG. 7, in the reduction rate adjustment processing shown at operation S3 in FIG. 8;

FIGS. 14A and 14B are diagrams showing a writing amount calculation method;

FIGS. 15A and 15B are diagrams showing examples of a list of page images displayed on a display screen 31; and

FIGS. 16A, 16B, 16C and 16D are diagrams showing the writing amount calculation method performed in the personal computer of this embodiment.

### DETAILED DESCRIPTION OF THE EMBODIMENTS

An embodiment of the present invention will be described below with reference to drawings.

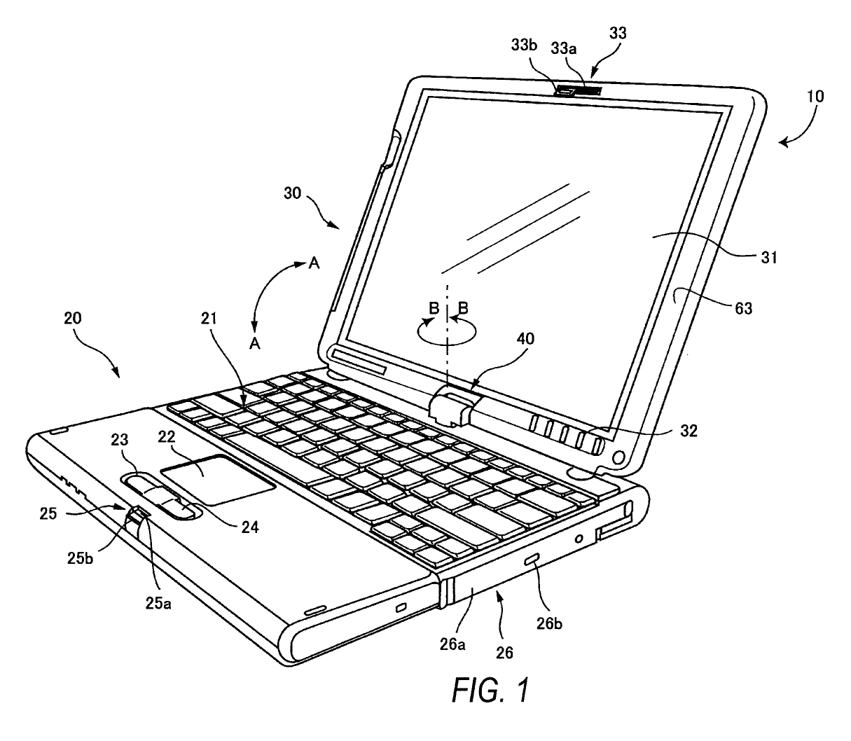

FIG. 1 is an external appearance perspective view of a personal computer to which an embodiment of the present invention is applied.

A personal computer 10 shown in FIG. 1 is a tablet PC which makes it possible to, by drawing a character or an image on a display screen 31 with a pen or a fingertip, input the contents of the drawing.

The personal computer 10 is provided with a first unit 20 and a second unit 30. The first unit 20 and the second unit 30 are coupled with each other via a biaxial coupling part 40 so that the second unit 30 can be freely opened and closed from and over the first unit 20 in the arrow A-A direction and can freely turn in the arrow B-B direction (around a perpendicular turning axis). FIG. 1 shows an electronic apparatus in a state that the second unit 30 is opened from the first unit 20 (an opened state).

The first unit 20 is provided with a keyboard 21, a trackpad 22, a left click button 23, a right click button 24, and a latch unit 25 which latches the second unit 30 when the second unit 30 is closed. The latch unit 25 is provided with a latch hole 25a into which a stopper on the second unit 30 side is inserted and a latch release button 25b which releases the latching state of the stopper inserted in the latch hole 25a. On the external surface of the side face of the first unit 20, there is an openable and closable cover 26a of an optical disk drive 26 in which an optical disk such as a CD and a DVD is mounted and which drives and accesses the optical disk. The openable and closable cover 26a of the optical disk drive 26 is provided with an eject button 26b which causes the openable and closable cover 26a to open by being pressed.

Over the front of the second unit 30 of the personal computer 10, the display screen 31 spreads. The second unit 30 is provided with some pushbuttons 32 below the display screen 31. Above the display screen 31 of the second unit 30, there is provided a stopper unit 33 equipped with a stopper to be latched with the latch unit 25 of the first unit 20 when the second unit 30 is closed. The stopper unit 33 is provided with two stoppers. In the example of FIG. 1, one stopper 33b between the two stoppers protrudes from an opening 33a on the display screen side.

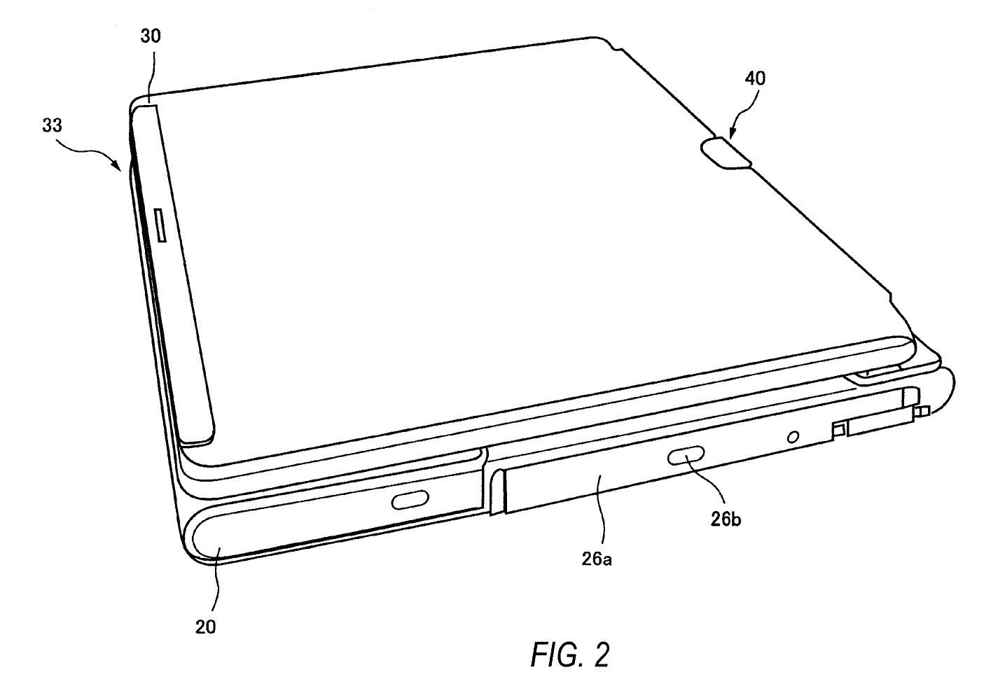

FIG. 2 is an external appearance perspective view showing an electronic apparatus with the second unit 30 closed over the first unit 20.

In FIG. 2, the second unit 30 is placed on the first unit 20 with the display screen 31 (see FIG. 1) faced with the first unit 20. Hereinafter, this state will be referred to as a first closed state.

When the second unit 30 is closed in the arrow A direction in the normal state shown in FIG. 1, the personal computer 10 transitions to the first closed state in which the display screen 31 is hidden inside and the back side of the display screen 31 is exposed outside as shown in FIG. 2. In this first closed state, it is possible to carry the personal computer 10 avoiding stain or breakage of the display screen 31.

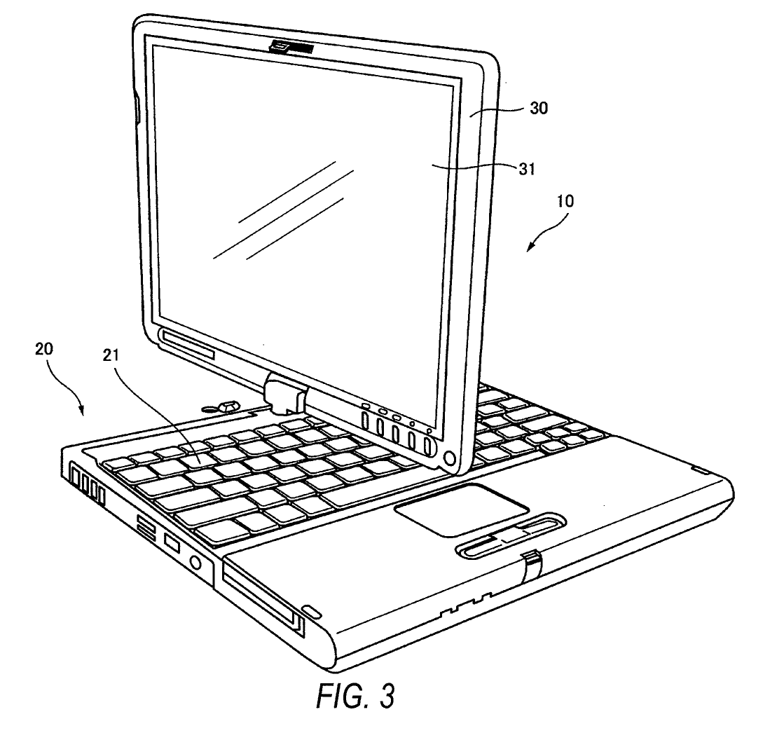

FIG. 3 is an external appearance perspective view showing that the second unit is turned by almost 90° relative to the first unit.

The second unit 30 can be turned so that the display screen 31 faces to the opposite side of the keyboard 21 after this state.

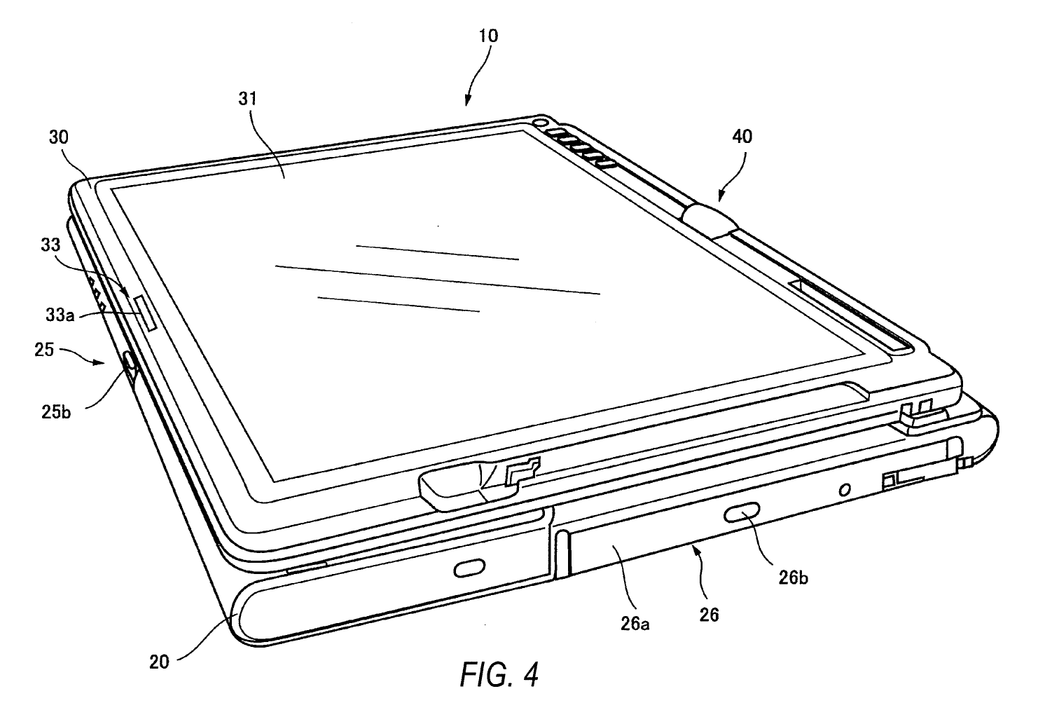

FIG. 4 is an external appearance perspective view showing that the second unit is placed on the first unit with the display screen directed upward.

The second unit 30 is further turned so that the display screen 31 faces to the opposite side of the keyboard 21 after the position shown in FIG. 3. Furthermore, by placing the second unit 30 on the first unit 20 with the back side of the display screen 31 of the second unit 30 facing to the first unit 20 in that state, the state shown in FIG. 4 is obtained. Hereinafter, this state will be referred to as a second closed state. This second closed state is a form for using the personal computer 10 as a tablet PC, and this is called a tablet mode here.

As described above, the display screen 31 is equipped with a pen input function for detecting contact by or a close position of a pen. Commonly, the personal computer 10 in this tablet mode is used by keeping it in one arm and operating the display screen with a pen (not shown) in the other hand. Because of the relationship with the line of sight when the personal computer 10 in the tablet mode is kept in the arm, the direction of a display image on the display screen 31 is turned by 90° in comparison with the normal state shown in FIG. 1.

On the second unit 30 of the personal computer 10 in the tablet mode shown in FIG. 4, the opening 33a of the stopper unit 33 is shown. This opening 33a is positioned on the same side of the display screen 31, and the opening 33a is also shown in FIG. 1. However, though the stopper 33b protrudes from the opening 33a in FIG. 1, a stopper does not protrude from the opening 33a in the tablet mode shown in FIG. 4. In the state shown in FIG. 4, another stopper protrudes from an opening (not shown) on the back side of the second unit 30, and the stopper is inserted in the latch hole 25a shown in FIG. 1 and latched. Therefore, the second unit 30 is kept being latched with the first unit 20 in the position shown in FIG. 4 as far as the latch release button 25b is not operated, and the personal computer 10 can be used as a tablet PC having a plate-type case as a whole.

Now, the internal configuration of the personal computer 10 will be described.

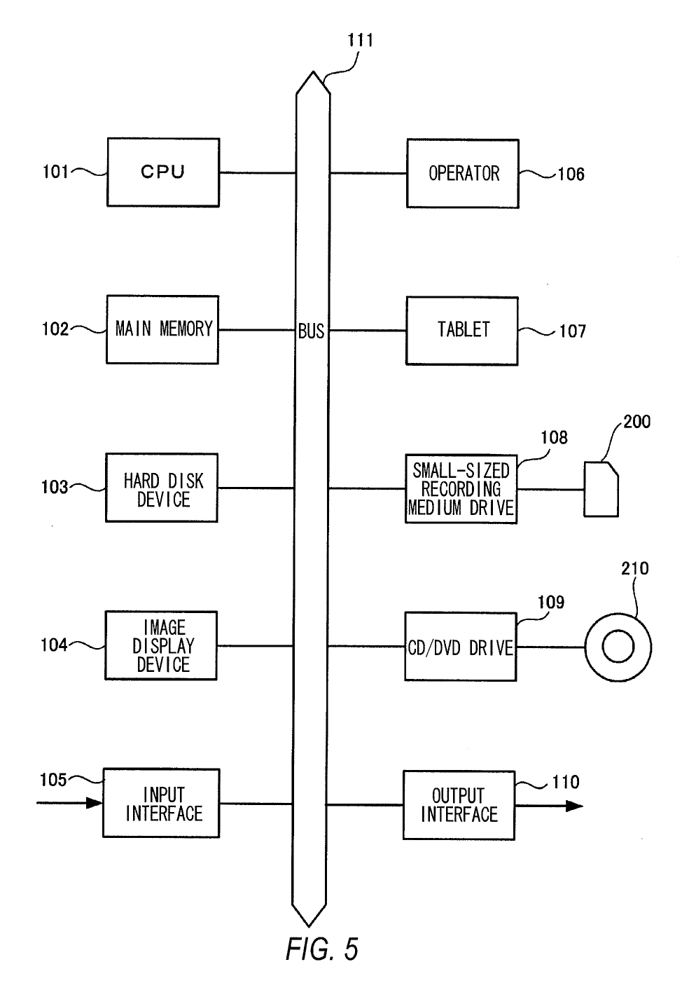

FIG. 5 is an internal configuration diagram of the personal computer 10.

As shown in FIG. 5, the personal computer 10 is provided with a CPU 101, a main memory 102, a hard disk device 103, an image display device 104, an input interface 105, an operator 106, a tablet 107, a CD/DVD drive 109, an output interface 110 and a bus 111. The CPU 101 executes various programs. On the main memory 102, a program stored in the hard disk device 103 is read and developed to be executed by the CPU 101. In the hard disk device 103, various programs, data and the like are stored. The image display device 104 displays an image on the display screen 31 shown in FIG. 1. The operator 106 includes the keyboard 21, the trackpad 22 and the like. The tablet 107 detects a contact position of a fingertip or a pen on the display screen 31. When a small-sized recording medium 200 is mounted, a small-sized recording medium drive 108 accesses the mounted small-sized recording medium 200. A CD-ROM 210 or a DVD is mounted in the CD/DVD drive 109, and the CD/DVD drive 109 accesses the mounted CD-ROM 210 or the DVD. The input interface 105 inputs data from an external apparatus. The output interface 110 outputs data to an external apparatus. These various components are connected to one another via the bus 111. A film resistance method is adopted by the tablet 107 in this embodiment. When a pen or finger touches the display screen 31, the position information indicating the contact position is generated.

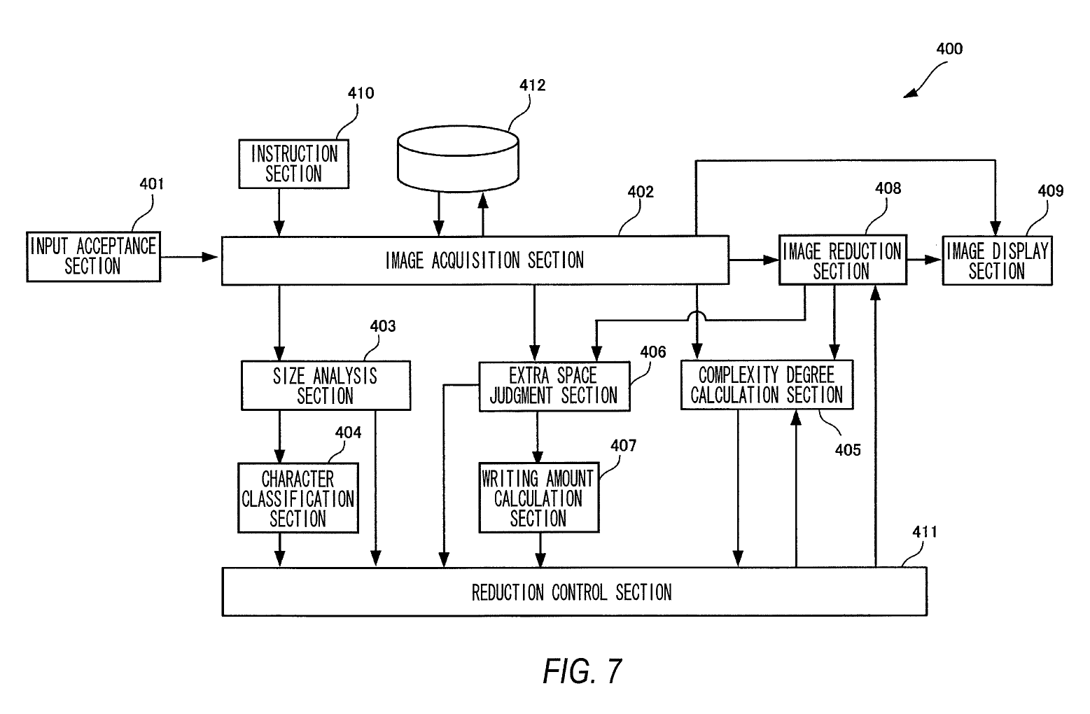

In the CD-ROM 210, there is stored an input/display program 300 to which an embodiment of the display program of the present invention and an embodiment of the input/display program of the present invention are applied. The CD-ROM 210 is mounted in the CD/DVD drive 109, and the input/display program 300 stored in the CD-ROM 210 is uploaded to the personal computer 10 and stored in the hard disk device 103. By the display program being activated and executed, an input/display device 400 (see FIG. 7) to which an embodiment of the display apparatus of the present invention and an embodiment of the input/display device of the present invention are applied is realized in the personal computer 10.

Next, description will be made on the input/display program 300 executed in this personal computer 10.

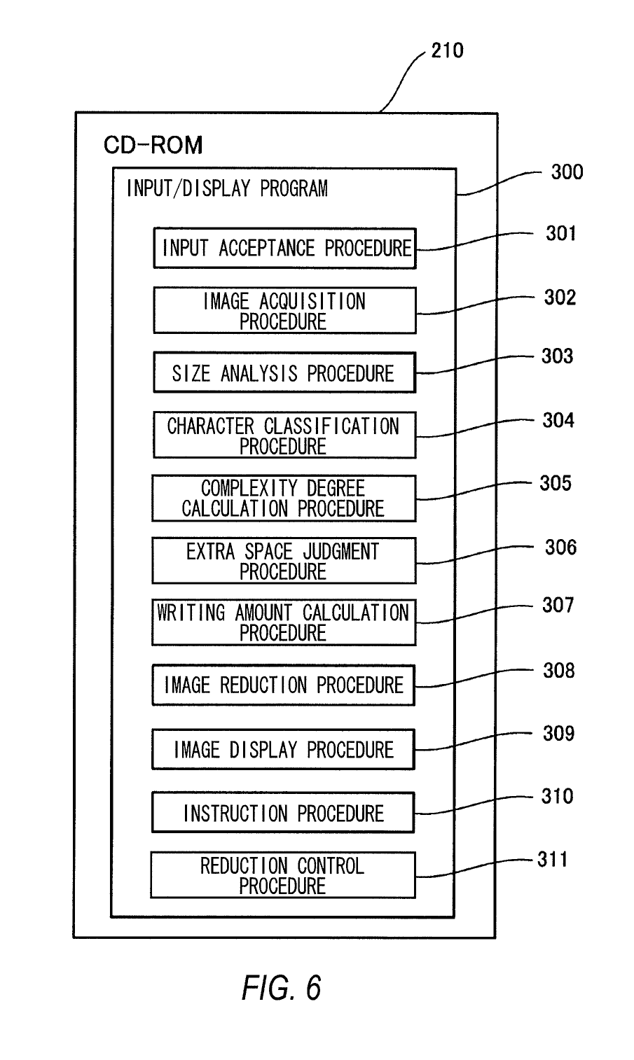

FIG. 6 is a conceptual diagram showing the CD-ROM 210 in which the input/display program 300 is stored.

The input/display program 300 causes a computer to execute an input acceptance procedure 301, an image acquisition procedure 302, a size analysis procedure 303, a character classification procedure 304, a complexity degree calculation procedure 305, an extra space judgment procedure 306, a writing amount calculation procedure 307, an image reduction procedure 308, an image display procedure 309, an instruction procedure 310 and a reduction control procedure 311. The details of each procedure of the input/display program 300 will be described together with the operation of each part of the input/display device 400.

Though the CD-ROM 210 is shown as an example of the storage medium in which the input/display program 300 is stored, the storage medium in which the display program and the input/display program of the present invention are stored is not limited to a CD-ROM. Storage media other than a CD-ROM, such as an optical disk, an MO, an FD and a magnetic tape, are also possible. Furthermore, the display program and input/display program of the present invention may be directly provided for the computer, not via a storage medium but via a communication network.

FIG. 7 is a functional block diagram of the input/display device 400 constructed in the personal computer 10 shown in FIG. 1 when the input/display program 300 is installed in the personal computer 10.

The input/display device 400 shown in FIG. 7 is provided with an input acceptance part 401, an image acquisition part 402, a size analysis part 403, a character classification part 404, a complexity degree calculation part 405, an extra space judgment part 406, a writing amount calculation part 407, an image reduction part 408, an image display part 409, an instruction part 410, a reduction control part 411 and a storage part 412. When the input/display program 300 shown in FIG. 6 is installed in the personal computer 10 shown in FIG. 1, the input acceptance procedure 301 of the input/display program 300 functions as the input acceptance part 401 in FIG. 7. Similarly, the image acquisition procedure 302 functions as the image acquisition part 402; the size analysis procedure 303 functions as the size analysis part 403; the character classification procedure 304 functions as the character classification part 404; the complexity degree calculation procedure 305 functions as the complexity degree calculation part 405; the extra space judgment procedure 306 functions as the extra space judgment part 406; the writing amount calculation procedure 307 functions as the writing amount calculation part 407; the image reduction procedure 308 functions as the image reduction part 408; the image display procedure 309 functions as the image display part 409; the instruction procedure 310 functions as the instruction part 410; and the reduction control procedure 311 functions as the reduction control part 411.

Each component in FIG. 7 is configured by combination of hardware of the computer and the OS or an application program executed on the computer, while each component of the input/display program 300 shown in FIG. 6 is configured only by an application program.

Hereinafter, by describing each component of the input/display device 400 shown in FIG. 7, each component of the input/display program 300 shown in FIG. 6 will be also described.

The tablet 107 shown in FIG. 5 plays the role of the input acceptance part 401. When a user draws something with a pen or a fingertip, the input acceptance part 401 detects the drawing position and accepts input of a character or an image. In this embodiment, when the whole display screen 31 is assumed to be one page, characters or images drawn by the user on the display screen 31 are collectively converted to an image, and page image data is generated. The input acceptance part 401 corresponds to an example of the input acceptance part stated in the present invention.

The image acquisition part 402 acquires the page image data generated by the input acceptance part 401. The image acquisition part 402 corresponds to an example of the image acquisition part stated in the present invention.

The size analysis part 403 analyzes the sizes of the characters included in the page image. The size analysis part 403 corresponds to an example of the size analysis part stated in the present invention.

The character classification part 404 acquires the character sizes analyzed by the size analysis part 403, and classifies the characters included in the page image data into multiple groups. The character classification part 404 corresponds to an example of the character classification part stated in the present invention.

The image reduction part 408 reduces the page image data with a predetermined reduction rate. When an instruction to suppress the reduction rate is communicated from the reduction control part 411, the image reduction part 408 reduces the page image with a suppressed reduction rate in accordance with the instruction. The image reduction part 408 corresponds to an example of the image reduction part stated in the present invention.

The extra space judgment part 406 judges whether there is an extra space or not when the reduced page image reduced by the image reduction part 408 is arranged on the display screen 31. The extra space judgment part 406 corresponds to an example of the extra space judgment part stated in the present invention.

When it is judged by the extra space judgment part 406 that there is an extra space, the writing amount calculation part 407 determines the total writing amount of the characters included in the page image. The writing amount calculation part 407 corresponds to an example of the writing amount calculation part stated in the present invention.

On the basis of the original page image before reduction and the reduced page image after reduction, the complexity degree calculation part 405 determines a complexity degree indicating the complexity of the images of characters in the page images. The complexity degree calculation part 405 corresponds to an example of the complexity degree calculation part stated in the present invention.

The reduction control part 411 adjusts the reduction rate used for reduction of the page image by the image reduction part 408, on the basis of the complexity degree, presence or absence of an extra space, the total writing amount of characters determined by the complexity degree calculation part 405, the extra space judgment part 406 and the writing amount calculation part 407, respectively. The reduction control part 411 corresponds to an example of the reduction control part stated in the present invention.

The hard disk device 103 shown in FIG. 5 plays the role of the storage part 412, and the page image generated by the input acceptance part 401 is stored in the storage part 412.

The keyboard 21, the trackpad 22, the left click button 23 and the right click button 24 play the role of the instruction part 410, and the instruction part 410 inputs an instruction in response to a user operation. The input/display device 400 of this embodiment is equipped with a list display function of displaying multiple page images stored in the storage part 412 as a list. When the user specifies an icon prepared in the input/display device 400 in advance and displayed, with a fingertip or a pen, an instruction to execute display of a list is inputted to the input/display device 400.

The image display part 409 displays the original page image before reduction or the reduced page image reduced by the image reduction part 408, on the display screen 31. The image display part 409 corresponds to an example of the image display part stated in the present invention.

The input/display device 400 is basically configured as described above.

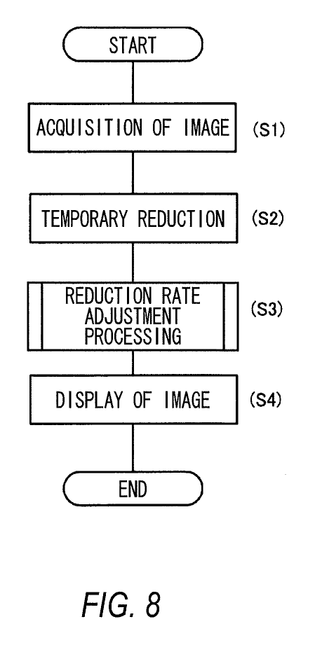

FIG. 8 is an operation flow showing a series of processings for displaying a list of page images in the input/display device 400.

Description will be made below on the flow of the series of processings for displaying a list of page images in the input/display device 400 in accordance with FIG. 8.

When a user selects an icon for “tablet PC” prepared in advance, with the use of the trackpad 22 or the like of the personal computer 10 shown in FIG. 1, the tablet 107 shown in FIG. 5 is activated, and the mode is switched to a tablet mode in which the personal computer 10 accepts a pen input. When the user draws characters and images on the display screen 31 in the tablet mode, the input acceptance part 401 in FIG. 7 collectively converts the characters and images drawn on the display screen 31 to an image and generates page image data indicating the image of the whole page. The generated image data is communicated to the image acquisition part 402 and stored in the storage part 412 (operation S1 in FIG. 8).

When the user specifies an icon for “list display” prepared on the display screen 31 of the personal computer 10 in advance, an instruction to execute display of a list is instructed from the instruction part 410 to the image acquisition part 402.

The image acquisition part 402 acquires all the page image data stored in the storage part 412, and the page image data is communicated to the size analysis part 403, the extra space judgment part 406, the complexity degree calculation part 405 and the image reduction part 408.

The image reduction part 408 temporarily reduces the page image data communicated from the image acquisition part 402 with a predetermined reduction rate (operation S2 in FIG. 8). In this embodiment, all the page images are temporarily reduced by the image reduction part 408 with the reduction rate of ⅓ uniformly. The page images after being temporarily reduced (hereinafter referred to as temporarily reduced page images) are communicated to the complexity degree calculation part 405 and the extra space judgment part 406.

When the page images are temporarily reduced, breakage of the characters in the temporarily reduced page images is detected on the basis of the original page images and the temporarily reduced page images, and the reduction rate is adjusted in accordance with the detection result (operation S3 in FIG. 8).

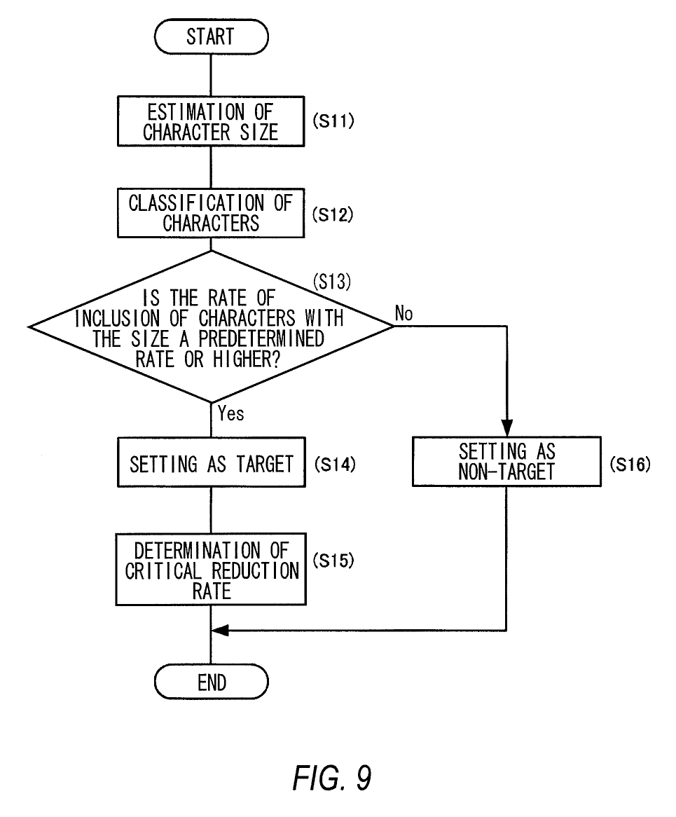

FIG. 9 is an operation flow showing a series of processings performed in the size analysis part 403, the character classification part 404 and the reduction control part 411 in FIG. 7, in the reduction rate adjustment processing shown at operation S3 in FIG. 8.

When the reduction rate adjustment processing is executed, the size analysis part 403 shown in FIG. 7 detects the characters in the original page images communicated from the image acquisition part 402, and the sizes of the detected characters are analyzed (operation S11 in FIG. 9). Since the character detection processing for detecting handwritten characters from an image is a well-known technique, detailed description thereof will be omitted in this specification. The characters detected by the size analysis part 403 and the sizes of the characters are communicated to the character classification part 404 and the reduction control part 411.

The character classification part 404 classifies the characters detected by the size analysis part 403 into multiple groups according to the sizes (operation S12 in FIG. 9).

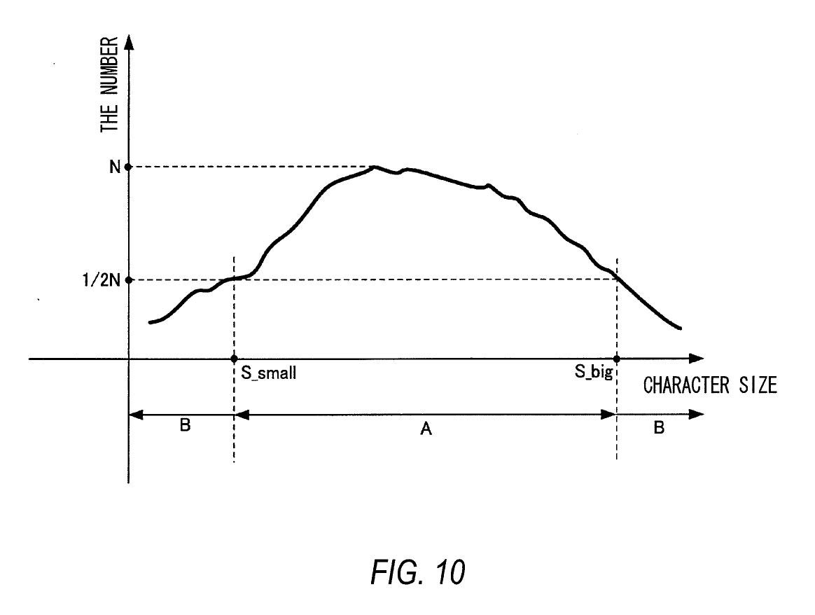

FIG. 10 is a graph showing an example of distribution of the sizes and the numbers of characters in a page image.

In FIG. 10, the horizontal axis corresponds to the character size and the vertical axis corresponds to the number of characters. The character classification part 404 classifies all the characters in a page image into multiple groups depending on whether the appearance frequency is relatively high or low. In this example, the characters are classified into two groups: a high appearance frequency group A including characters with such sizes that the number of appearances is ½N or larger and a low appearance frequency group B including characters with such sizes that the number of appearances is smaller than ½N, when N is the total number of characters with the highest appearance frequency size. The classification result is communicated to the reduction control part 411.

When acquiring the classification result from the character classification part 404, the reduction control part 411 sets the characters classified into the high frequency group A including characters with relatively high appearance frequency sizes (operation S13 in FIG. 9: Yes) as characters targeted by calculation of a complexity degree to be described later (operation S14 in FIG. 9). The reduction control part 411 sets the characters classified into the low frequency group B including characters with relatively low appearance frequency sizes (operation S13 in FIG. 9: No) as characters which are not targeted by the complexity degree calculation (operation S16 in FIG. 9). For example, the Japanese hiragana character “ [symbol] ” which is written smaller than the ordinary “ [symbol] ” is more easily broken when reduced, in comparison with other characters. However, the whole sentence can be understood even if the character cannot be recognized, because the number of appearances of the character is small. By setting such a character appearing few times as a character not to be targeted by the complexity degree calculation, characters which appear many times and are considered to be important can be reducedly displayed with recognizable sizes, and the rate of understanding of the whole sentence can be kept. The contents of the setting are communicated to the complexity degree calculation part 405.

Furthermore, the reduction control part 411 determines, on the basis of the character sizes communicated from the size analysis part 403 and a predetermined minimum character size, such a critical reduction rate of the page image that the sizes of the characters targeted by the complexity degree calculation are not smaller than the minimum character size (operation S15 in FIG. 9). There may be a case where a character with the same size can or cannot be visually recognized depending on the resolution of the display screen 31 or the character color in the page image. By acquiring the minimum recognizable character size in advance and adjusting the reduction rate so that the sizes of the characters in the page image after reduction are not below the minimum character size, the characters in the page image after reduction can be certainly identified.

The processings described above are executed by the size analysis part 403, the character classification part 404 and the reduction control part 411.

Now, processings executed by the complexity degree calculation part 405, the image reduction part 408 and the reduction control part 411 will be described.

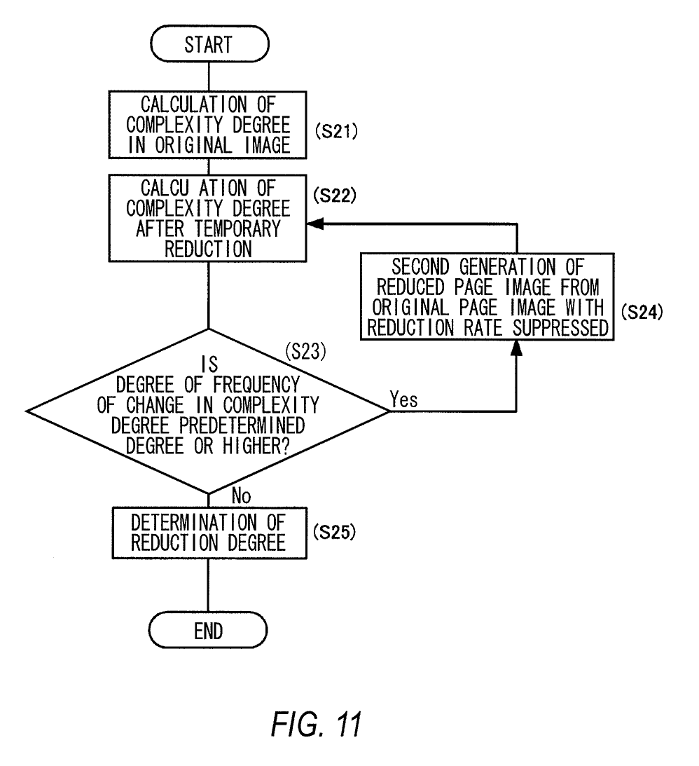

FIG. 11 is an operation flow showing a series of processings performed in the complexity degree calculation part 405, the image reduction part 408 and the reduction control part 411 in FIG. 7, in the reduction rate adjustment processing shown at operation S3 in FIG. 8.

The complexity degree calculation part 405 first determines, on the basis of the original page image data communicated from the image acquisition part 402, a complexity degree indicating the complexity of the image structure of the characters in the page image (operation S21 in FIG. 11). The complexity degree stated here means a complexity degree indicating the complexity of the image structure of the characters set as characters targeted by the complexity degree calculation at operation S14 in FIG. 9 (operation S21 in FIG. 11).

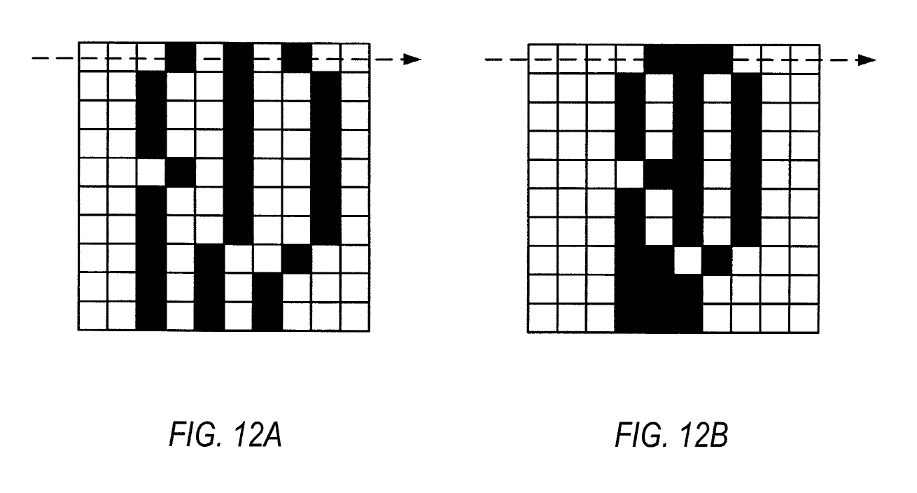

FIGS. 12A and 12B are diagrams for illustrating a complexity degree calculation method.

In this embodiment, the complexity degree calculation part 405 divides the page image data into multiple pixel areas, and horizontal-direction scanning is performed for each character in the page image data to check the presence or absence of drawing in each pixel area. The number of changes in the state of drawing is determined as the complexity degree. In the example shown in FIG. 12A, the drawing states of the pixel areas on the top line are “absent, absent, absent, present, absent, present, absent, present, absent, absent” from the left end to the right end, changing six times, and therefore, the complexity degree of the top line of this character is determined as “6”. This complexity degree is calculated for each character in the page image and for each line of multiple pixel areas, and the calculated complexity degree is communicated to the reduction control part 411 shown in FIG. 7.

The complexity degree calculation part 405 determines, on the basis of the temporarily reduced page image sent from the image reduction part 408, the complexity degree of each of the characters set as characters targeted by the complexity degree calculation in the temporarily reduced page image (operation S22 in FIG. 11).

In this embodiment, the complexity degree is determined similarly to operation S21, on the basis of a temporarily reduced page image obtained by reducing a page image in the horizontal direction at a temporary reduction rate. In FIG. 12B, the original character shown in FIG. 12A has been reduced in the horizontal direction with a temporary reduction rate (⅓). The drawing states of the pixel areas on the top line are “absent, absent, absent, absent, present, present, present, absent, absent, absent” from the left end to the right end, changing twice. The complexity degree of the top line of the character after the reduction is determined as “2”, and the determined complexity degree is sent to the reduction control part 411 shown in FIG. 7.

The reduction control part 411 compares the complexity degree of each character in the original page image and the complexity degree of the character in the temporarily reduced page image with each other. If the degree of the change in the complexity degree is a predetermined degree (in this embodiment, 50% of the complexity degree in the original page image) or higher (operation S23 in FIG. 11: Yes), the reduction control part 411 sends an enlargement instruction to the image reduction part 408. In the examples of FIGS. 12A and 12B, the complexity degree changes from “6” to “2”, decreasing by “4”, that is, it changes by more than “3”, 50% of the original complexity degree “6”, and therefore, an enlargement instruction is sent from the reduction control part 411 to the image reduction part 408.

When receiving the enlargement instruction from the reduction control part 411, the image reduction part 408 changes the reduction rate so that the temporarily reduced page image becomes a little larger (operation S24 in FIG. 11). In this embodiment, a page image is reduced at a temporary reduction rate (in this example, ⅓) first. The image reduction part 408 generates a temporarily reduced page image obtained by reducing the original page image with the second temporary reduction rate (in this example, ⅖) so that the temporarily reduced page image becomes a little larger. The generated temporarily reduced page image data is sent to the complexity degree calculation part 405 and the reduction control part 411.

The complexity degree calculation part 405 determines the complexity degree of the characters in the new temporarily reduced page image (operation S22 in FIG. 11). The reduction control part 411 compares the complexity degree of the characters in the new temporarily reduced page image and the complexity degree of the characters in the original page image with each other (operation S23 in FIG. 11).

The image reduction part 408 generates a new temporarily reduced page image from the original page image data, with the temporary reduction rate suppressed by a predetermined rate ( 1/15 added, in this example). The complexity degree calculation part 405 calculates the complexity degree of the characters in the new temporarily reduced page image. Then, the reduction control part 411 compares the complexity degree of the characters in the new temporarily reduced page image and the complexity degree of the characters in the original page image with each other. The series of processings is continued until the difference between the complexity degree of the characters in the original page image and the complexity degree of the characters in the temporarily reduced page image becomes less than a predetermined degree (in this embodiment, 50% of the complexity degree in the original page image).

When the difference between the complexity degree of each character in the temporarily reduced page image and that of the character in the original page image becomes less than the predetermined degree (operation S23 in FIG. 11: No), the reduction control part 411 compares the temporary reduction rate of the temporarily reduced page image and the critical reduction rate determined at operation S15 in FIG. 9 with each other. If the temporary reduction rate has reached the critical reduction rate, the critical reduction rate is determined as the actual reduction rate. If the temporary reduction rate has not reached the critical reduction rate, the temporary reduction rate is determined as the actual reduction rate (operation S25 in FIG. 11). The determined reduction rate is communicated to the image reduction part 408.

By the processings as described above being executed for each of all the page images stored in the storage part 412, the reduction rate of each page image is determined. By applying the reduction rate determined in this way, each page image can be reduced to a size which enables recognition of the characters in the page image and displayed. In this embodiment, the reduction rate is further adjusted so that the characters included in each page image can be displayed as large as possible.

In this embodiment, the complexity degree is calculated by scanning a page image in the horizontal direction. However, by scanning the page image in the vertical direction also to calculate the complexity degree, and checking change in the complexity degree in both the horizontal and vertical directions to judge the degree of breakage of the characters, the breakage judgment accuracy can be improved. In this case, for example, a reduced image obtained by reducing a page image in the horizontal direction is scanned in the horizontal direction, and, if the ratio of the number of such lines that the degree of change in the complexity degree is a predetermined degree (for example, 50% of the complexity degree of the original page image) or below to the number of all the lines is a predetermined ratio (for example, 80%) or higher, it is judged that breakage has not occurred. Subsequently, as for the vertical direction also, a reduced image obtained by reducing the page image in the vertical direction may be scanned in the vertical direction similarly. If the ratio of the number of such lines that the degree of change in the complexity degree is a predetermined degree (for example, 50% of the complexity degree of the original page image) or lower to the number of all the lines is a predetermined ratio (for example, 80%) or higher, it is judged that breakage has not occurred.

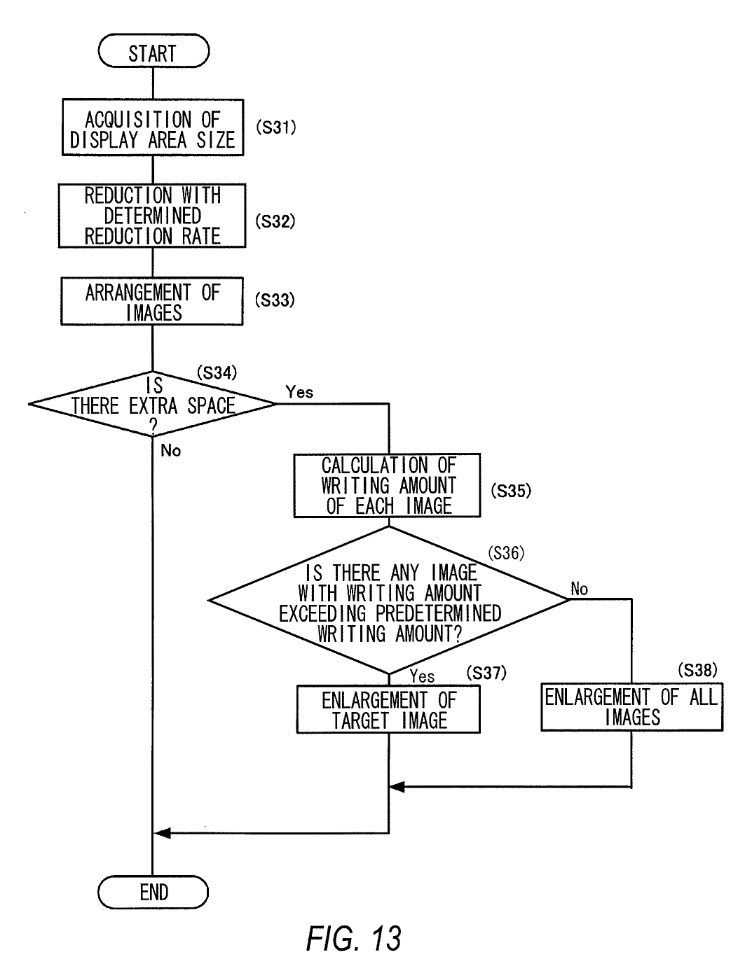

FIG. 13 is an operation flow showing a series of processings performed in the extra space judgment part 406, the writing amount calculation part 407, the image reduction part 408 and the reduction control part 411 in FIG. 7, in the reduction rate adjustment processing shown at operation S3 in FIG. 8.

The extra space judgment part 406 acquires the size of the display area of the display screen 31 shown in FIG. 1 (operation S31 in FIG. 13).

The image reduction part 408 reduces all the page images communicated from the image acquisition part 402 with the reduction rate determined for each page image by the reduction control part 411 (operation S32 in FIG. 13), and removes space areas in which a character or an image is not drawn from each reduced page image. All the reduced page images from which the space areas have been removed are communicated to the extra space judgment part 406.

The extra space judgment part 406 arranges all the reduced page images communicated from the image reduction part 408 together on the area having the size acquired at operation S31 (operation S33 in FIG. 13) and judges whether or not there is an extra space on the area. If it is judged that there is not an extra space (operation S34 in FIG. 13: No), the judgment result is communicated to the reduction control part 411, and determination of a reduction rate is communicated from the reduction control part 411 to the image reduction part 408. The image reduction part 408 communicates all the reduced page images from which an extra area has been removed, to the image display part 409.

If it is judged that there is an extra space (operation S34 in FIG. 13: Yes), the judgment result is communicated from the extra space judgment part 406 to the writing amount calculation part 407.

The writing amount calculation part 407 acquires all the original page images from the image acquisition part 402 and, for each of all the page images, calculates the writing amount of the characters in the page image (operation S35 in FIG. 13).

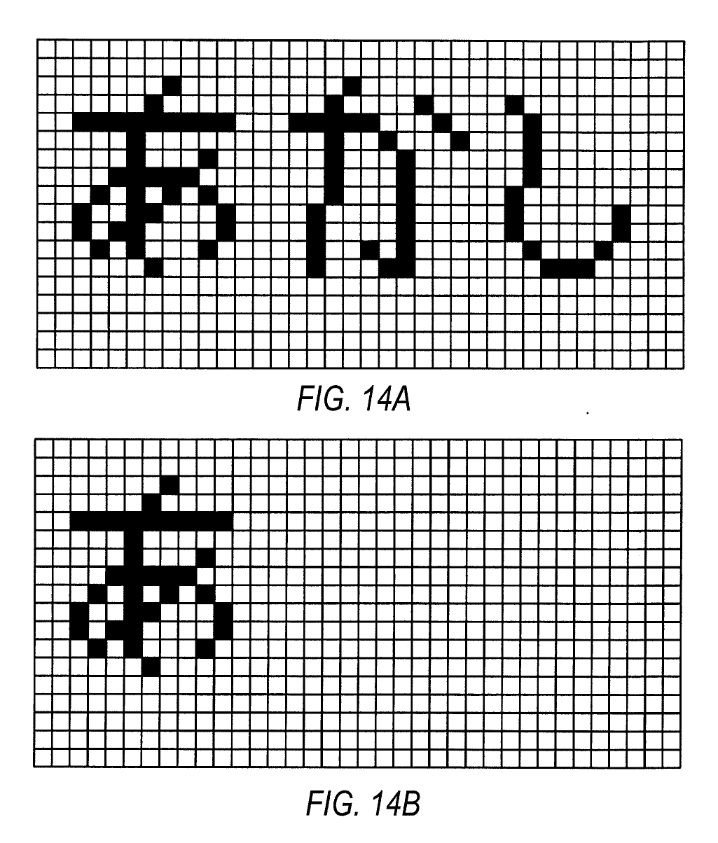

FIGS. 14A and 14B are diagrams showing a writing amount calculation method.

In this embodiment, the drawing area in which characters and images are drawn relative to the whole area of each page image is calculated as a writing amount. In FIG. 14A, the area of the whole page image is indicated by “18×36” squares, and the drawing area is indicated by “35+28+15”, and the writing amount is calculated as “78/648”. In FIG. 14B, the writing amount is calculated as “35/648”.

The writing amount calculated by the writing amount calculation part 407 is communicated to the reduction control part 411.

The reduction control part 411 judges, for each of all the page images to be displayed as a list, whether or not the writing amount calculated by the writing amount calculation part 407 exceeds a predetermined writing amount. If there is a page image with a writing amount exceeding the predetermined writing amount (operation S36 in FIG. 13: Yes), an instruction to suppress the reduction rate of the page image is communicated from the reduction control part 411 to the image reduction part 408. Then, the reduction control part 411 generates a new reduced page image with a reduction rate obtained by suppressing the reduction rate of the page image by a predetermined rate (operation S37 in FIG. 13). Thus, if there is an extra space when reduced page images are arranged together, the reduction rate of a page image with a large writing amount is suppressed, and thereby, a sentence written with a lot of characters and difficult to read, and the like can be displayed a little larger.

If there is not a page image with a writing amount exceeding the predetermined writing amount (operation S36 in FIG. 13: No), an instruction is given to suppress the reduction rate of all the page images, from the reduction control part 411 to the image reduction part 408. Then, the reduction control part 411 generates new reduced page images by suppressing the reduction rates of all the page images by a predetermined rate (operation S38 in FIG. 13).

For each of all the page images, if a new reduced page image is generated, the image reduction part 408 communicates the new reduced page image to the image display part 409. As for a page image for which a new reduced page image is not generated, the reduced page image generated at operation S32 is communicated to the image display part 409.

Returning to FIG. 8, description will be made.

The reduced page images generated as described above are arranged together and displayed by the image display part 409 on the display screen 31 shown in FIG. 1 (operation S4 in FIG. 8).

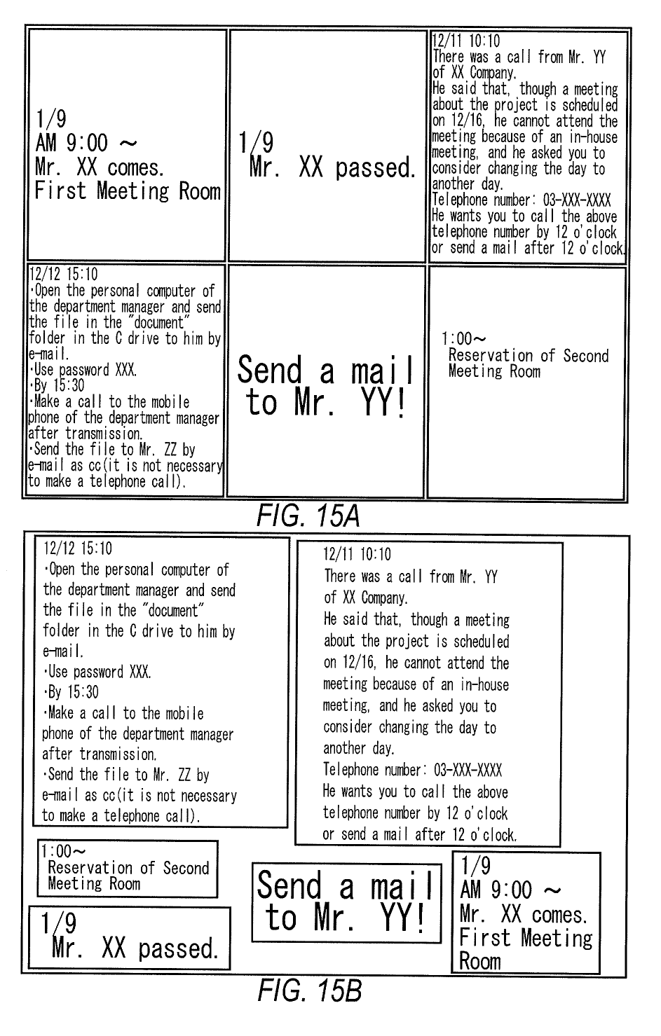

FIGS. 15A and 15B are diagrams showing examples of a list of page images displayed on the display screen 31.

In this embodiment, as for page images which include a sentence written by small characters, page images with a large writing amount, and the like, the reduction rate is suppressed as shown in FIG. 15B. Furthermore, since parts where a characters or an image is not drawn are removed, it is possible to visually recognize the contents of each page image even when multiple page images are displayed as a list.

The first embodiment of the present invention has been described. Now, a second embodiment of the present invention will be described. The second embodiment of the present invention has the same configuration as the first embodiment shown in FIG. 7. However, only the writing amount calculation method used by the writing amount calculation part 407 is different from the first embodiment. Therefore, FIG. 7 is also used for description of the second embodiment, and only the points different from the first embodiment will be described.

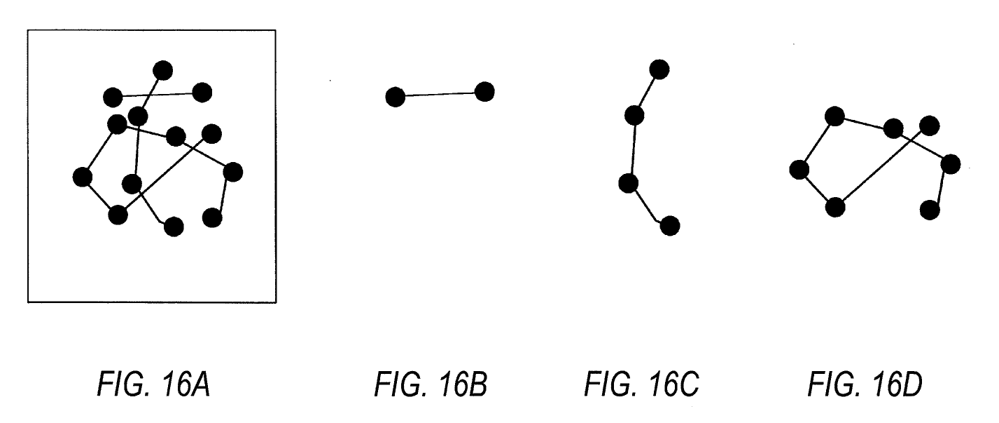

FIGS. 16A, 16B, 16C and 16D are diagrams showing a writing amount calculation method in the personal computer of this embodiment.

In the personal computer of this embodiment, lines drawn by a user are sampled and detected as coordinate values on the display screen 31. For example, for a Japanese hiragana character “ [symbol] ” shown in FIG. 16A, the writing amount calculation part of this embodiment detects the three lines shown in FIGS. 16B, 16C and 16D on the basis of the operation of causing the pen point to be in contact with or apart from the display screen 31. Furthermore, the length of each line is acquired on the basis of the coordinates of passing points of each line, and the total length of the acquired lengths of the three lines is determined as the writing amount of the character.

The determined writing amount is communicated to the reduction control part 411 shown in FIG. 7 and used for adjustment of the reduction rate.

Thus, by calculating a writing amount on the basis of the length of lines drawn by a user, it is possible to calculate a writing amount based on the number of characters actually written or the complexity of the character structure.

Though description has been made on a tablet PC to which the film resistance method is applied, the character input part stated in the present invention may be such as adopts the electromagnetic induction method, the infrared method, the capacitance method or the like.

Furthermore, though description has been made on an example in which the complexity degree is calculated on the basis of the number of changes between presence and absence of drawing, the complexity degree calculation part stated in the present invention may calculate the complexity degree on the basis of the number of turns of a line by using the fact that the bending parts of a line are omitted when a character is reduced.

Furthermore, though description has been made on an example in which the character-input enabling display apparatus of the present invention is applied to a tablet PC, the character-input enabling display apparatus of the present invention may be applied to an electronic notebook.

What is claimed is:

1. A display apparatus comprising:
an image acquisition part which acquires image data of a page on which characters are written;
an image reduction part which reduces the image data of the page at a predetermined reduction rate;
a complexity degree calculation part which, by analyzing an image structure of a character in the image data, calculates a complexity degree on which a complexity of the image structure is reflected;
a reduction control part which determines the reduction rate for the image reduction by the image reduction part so that the complexity degree is kept to a predetermined extent even after the reduction; and
an image display part which displays the image data reduced by the image reduction part.

2. The display apparatus according to claim 1, wherein the complexity degree calculation part determines the number of changes between a state with drawing and a state without drawing on a line across the image of a character written on the page in a predetermined direction, as the complexity degree.

3. The display apparatus according to claim 1, comprising a character classification part which classifies characters in the image acquired by the image acquisition part into multiple groups according to sizes; wherein
the complexity degree calculation part calculates the complexity degree for the images of characters belonging to a group in which relatively many characters are classified among the multiple groups.

4. The display apparatus according to claim 1, wherein
the image acquisition part acquires the image data of each of multiple pages;
the image reduction part reduces the image for each of the multiple pages;
the display apparatus comprises a writing amount calculation part which determines, for each of the multiple pages, the total writing amount of the characters written in the page;
the reduction control part determines, for each of the multiple pages, a reduction rate on the basis of the complexity degree, and, for pages with a relatively large total writing amount among the multiple pages, controls the reduction rate in comparison with the other pages; and
the image display part displays the multiple images reduced by the image reduction part arranged together;

5. The display apparatus according to claim 4, wherein the writing amount calculation part determines the drawing area of the images of the characters relative to the area of the page as the total writing amount.

6. The display apparatus according to claim 4, wherein the writing amount calculation part determines the total length of the lines constituting the characters in the page as the total writing amount.

7. The display apparatus according to claim 6, wherein
the display apparatus comprises an extra space judgment part which judges whether there is an extra space in the display area when multiple images are displayed by the image display part; and
the reduction control part executes the suppression of the reduction rate based on the total writing amount if it is judged by the extra space judgment part that there is an extra space.

8. The display apparatus according to claim 1, comprising a size analysis part which analyzes the size of the characters in the image data acquired by the image acquisition part; wherein
for each of the multiple pages, the reduction control part suppresses the reduction rate on the basis of the complexity degree and controls the reduction rate so that the size of the characters after reduction is not below a predetermined minimum size.

9. The display apparatus according to claim 1, further comprising a character input part which accepts input of characters; wherein
the image acquisition part acquires the image data of a page in which the characters accepted by the character input part are written.

10. A computer-readable recording medium storing a display program causing a computer to execute as a display apparatus, said display program comprising the operations of:
acquiring image data of a page on which characters are written;
reducing the image data of the page at a predetermined reduction rate;
calculating a complexity degree on which a complexity of the image structure is reflected by analyzing the image structure of the image of a character in the image data;
determining the reduction rate for the image reduction so that the complexity degree is kept to a predetermined extent even after the reduction; and
displaying the reduced image.

11. A display method of causing a computer to execute as a display apparatus, said display method comprising the operations of:
acquiring image data of a page on which characters are written;
reducing the image data of the page at a predetermined reduction rate;
calculating a complexity degree on which a complexity of the image structure is reflected by analyzing the image structure of the images of a character in the image data;
determining a reduction rate for an image reduction so that a complexity degree before the image reduction is kept to a predetermined extent even after the image reduction; and
displaying the reduced image;
